(19) United States
(12) Patent Application Publication
(10) Pub. No.: US 2025/0383693 A1
(43) Pub. Date: Dec. 18, 2025

(54) FAN DRIVING CHIP, FAN DETECTION METHOD, AND SMART FAN

(71) Applicant: NUVOTON TECHNOLOGY CORPORATION, HSINCHU CITY (TW)

(72) Inventor: PING-YING CHU, Zhubei City (TW)

(21) Appl. No.: 18/949,298

(22) Filed: Nov. 15, 2024

(30) Foreign Application Priority Data
Jun. 12, 2024 (TW) 113121703

(51) Int. Cl. G06F 1/20

(52) U.S. Cl. CPC G06F 1/20

(57) ABSTRACT

A fan driving chip for detecting a type of a fan electrically connected to the fan driving chip and driving the fan is provided. The fan driving chip includes: a first specific chip pin adapted for receiving a signal from the fan; a second specific chip pin; a chip control module electrically connected to the first specific chip pin and the second specific chip pin. When detecting that the signal includes specific data with a specific pattern, the chip control module determines that the fan is a smart fan capable of supporting a specific function, and triggers an exchange of at least one acknowledgement signal with the fan through the first specific chip pin and the second specific chip pin to control a rotation speed and the specific function of the fan, wherein a specific effect of the specific function is a function other than fan rotation.

### CROSS-REFERENCE TO RELATED APPLICATION

This application claims the priority from the TW Patent Application No. 113121703, filed on Jun. 12, 2024, and all contents of such TW Patent Application are comprised in the present disclosure.

### BACKGROUND

### 1. Field of the Invention

The present disclosure is related to a fan driving chip, a fan detection method, and a smart fan, and in particular to a fan driving chip adapted for detecting a type of a fan, a fan detection method adapted for detecting a type of a fan, and a smart fan adapted for detecting a type of a chip.

### 2. Description of the Related Art

With progress in technologies, various electronic devices (e.g., processor, display card, etc.) have higher and higher operating frequencies and power consumption. To prevent these devices from overheating and causing damage to electronic devices, heat dissipation devices are usually required to reduce the temperatures of these devices. Installing fans for heat dissipation is a common solution. By rotating, fans generate airflow that removes the hot air around the components, achieving a cooling effect. Common types of fans typically include three-wire direct current (DC) fans, four-wire pulse width modulation (PWM) fans, red-green-blue (RGB) fans, and addressable RGB (ARGB) fans. These types differ in connector types and driving control methods.

An ARGB fan is a type of heat dissipation fan equipped with an addressable light strip, which can be used in gaming computers. To enable the addressable light strip to flash, an ARGB controller must be built into a motherboard (MB) to control the color and brightness of each light-emitting diode (LED) on the light strip, thereby achieving a variety of dynamic lighting effects (during heat dissipation). Specifically, through the characteristic of visual persistence, it creates the phenomenon/illusion of flowing lights to the human eye.

When an ARGB fan is built with (a function of) an ARGB controller, the flashing mode of the light strip can be controlled through a system fan controller with either three pins or four pins. As a result, the application market for ARGB fans has expanded beyond high-end gaming motherboards, allowing all motherboards to be equipped with these dazzling fans.

However, electronic devices may be designed to support only specific types of fans. In this case, users of the electronic device must choose the specific fan compatible with the device. This can be inconvenient for those who are unfamiliar with the fan specifications of the electronic device. For example, when choosing a fan for a computer, users must first check the motherboard of the computer to understand which type of fan the computer supports.

Thus, effectively determining the fan type and providing the correct driving method and electronic device (ensuring that the fan and device are effectively matched) becomes an important issue worth studying.

### SUMMARY

To solve the above technical problems, the present disclosure provides a fan driving chip, a fan detection method, and a smart fan to effectively detect a fan type and a chip type and provide a correct driving method.

An embodiment of the present disclosure provides a fan driving chip for detecting a type of a fan electrically connected to the fan driving chip, including: a first specific chip pin adapted for receiving a signal from the fan; a second specific chip pin; a chip control module electrically connected to the first specific chip pin and the second specific chip pin, wherein: when detecting that the signal includes specific data with a specific pattern, the chip control module determines that the fan is a smart fan capable of supporting a specific function, and triggers an exchange of at least one acknowledgement (ACK) signal with the fan through the first specific chip pin and the second specific chip pin to control a first rotation speed and the specific function of the fan, wherein a specific effect of the specific function is a function other than fan rotation.

Another embodiment of the present disclosure provides a fan detection method applied to detect a type of a fan electrically connected to a fan driving chip, wherein the fan driving chip supports an addressable RGB (ARGB) function, and the fan detection method includes: receiving a signal from the fan through a first specific chip pin of the fan driving chip; detecting whether the signal includes specific data with a specific pattern through a chip control module of the fan driving chip; when detecting that the signal includes the specific data with the specific pattern, determining that the fan is a smart fan capable of supporting the ARGB function, and triggering an exchange of at least one acknowledgement signal with the fan through the first specific chip pin and a second specific chip pin of the fan driving chip to control a first rotation speed and a lighting effect; and when detecting that the signal does not include the specific data with the specific pattern, determining that the fan is a direct current (DC) fan or a pulse width modulation (PWM) fan that does not support the ARGB function, and controlling a second rotation speed of the fan based on a determination result.

Another embodiment of the present disclosure provides a smart fan adapted for detecting a type of a chip electrically connected to the smart fan, wherein the smart fan is capable of supporting an addressable RGB (ARGB) function and includes: a first specific fan pin adapted for transmitting first specific data with a specific pattern to the chip; a second specific fan pin adapted for receiving a signal from the chip; a fan control module electrically connected to the first specific fan pin and the second specific fan pin, and adapted for: when detecting that the signal includes second specific data with the specific pattern, the fan control module determines that the chip is a fan driving chip that supports the ARGB function, controls the smart fan to operate using an ARGB mode, and triggers an exchange of at least one acknowledgement signal with the chip through the first specific fan pin and the second specific fan pin to control a first rotation speed and a lighting effect of the smart fan.

Based on the above, embodiments of the present disclosure can effectively achieve detecting the fan type and the chip type and providing the correct driving of the fan.

To further understand the technology, means, and effects of the present disclosure, reference may be made by the detailed description and drawing as follows. In this way, the purposes, features and concepts of the present disclosure can be thoroughly and concretely understood. However, the following detail description and drawings are only used to reference and illustrate the implementation of the present disclosure, and they are not used to limit the present disclosure.

### BRIEF DESCRIPTION OF THE DRAWINGS

The drawings are provided to make the persons with ordinary knowledge in the field of the art further understand the present disclosure, and are incorporated into and constitute a part of the specification of the present disclosure. The drawings illustrate demonstrated embodiments of the present disclosure, and are used to explain the principal of the present disclosure together with the description of the present disclosure.

FIG. 1 is a schematic circuit diagram of a fan driving chip according to an embodiment of the present disclosure;

FIG. 2 is a schematic flow chart of a fan detection method according to an embodiment of the present disclosure;

FIG. 3 is a schematic circuit diagram of a smart fan according to an embodiment of the present disclosure; and

FIG. 4 is a schematic flow chart of a chip detection method adapted for a smart fan according to an embodiment of the present disclosure.

### DESCRIPTION OF THE PREFERRED EMBODIMENTS

The present disclosure provides a fan driving chip, a fan detection method, and a smart fan to solve the problems mentioned above. The embodiments of the present disclosure are described in detail as reference, and the drawings of the present disclosure are illustrated. In the case of possibility, the element symbols are used in the drawings to refer to the same or similar components. In addition, the embodiment is only one approach of the implementation of the design concept of the present disclosure, and the following multiple embodiments are not intended to limit the present disclosure.

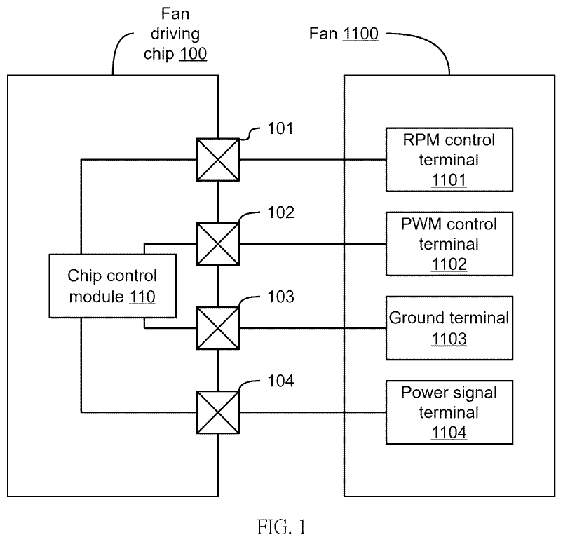

FIG. 1 is a schematic circuit diagram of a fan driving chip according to an embodiment of the present disclosure. The disclosed fan driving chip is for detecting whether the connected fan is a smart fan. The smart fan can perform a specific function other than fan rotation. In an embodiment, the specific function may be a lighting function (e.g., addressable RGB (ARGB) function), a display function, a temperature detection, or a fragrance atomization function, etc. The fan driving chip may drive the smart fan to generate the lighting effect, the display effect, the temperature detection effect, and the fragrance effect. In this embodiment, the (smart) fan driving chip 100 supports the ARGB function and is adapted for detecting a type of the fan 1100 electrically connected to the (smart) fan driving chip 100 and correspondingly driving/controlling the fan 1100. However, this is merely an example, and the scope of application of this disclosure is not limited to this embodiment. The fan driving chip 100 may be, for example, a super input/output (SIO) chip, circuit, or device, but the present disclosure is not limited herein. The type of the fan 1100 may be, for example, a direct current (DC) fan, a pulse width modulation (PWM) fan, a RGB fan, or an ARGB fan.

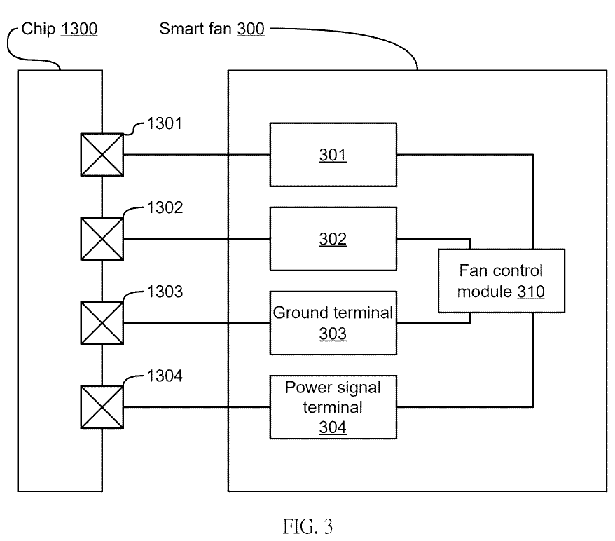

The fan driving chip 100 includes: a first specific chip pin 101, a second specific chip pin 102, and a chip control module 110 electrically connected to the first specific chip pin 101 and the second specific chip pin 102. The first specific chip pin 101 is adapted for receiving a signal or a packet from the fan 1100 (e.g., a fan pin corresponding to the first specific chip pin 101). The chip control module 110 is adapted for detecting whether the signal includes specific data with a specific (e.g., preset) pattern. When detecting that the signal includes the specific data with the specific pattern, the chip control module 110 determines that the fan 1100 is a smart fan (e.g., the smart fan 300 illustrated in FIG. 3) capable of supporting the ARGB function, and triggers an exchange of at least one acknowledgement (ACK) signal with the fan 1100 through the first specific chip pin 101 and the second specific chip pin 102 to control a first rotation speed and a lighting effect of the fan 1100.

In some embodiments, when detecting that the signal does not include the specific data with the specific pattern, the chip control module 110 may determine that the fan 1100 is a DC fan or a PWM fan that does not support the ARGB function and control a second rotation speed of the fan 1100 based on a determination result. It should be noted that there are various methods for determining whether a fan is a DC fan or a PWM fan, as well as corresponding methods for driving the fan (e.g., refer to Taiwanese Patent I344591), which will not be described in detail here.

In some embodiments, the fan driving chip 100 may use a UART protocol (or interface) or an I2C interface to communicate with the fan 1100. When detecting that the signal includes the specific data with the specific pattern and the UART protocol is used, the chip control module 110 may trigger transmission of a chip acknowledgment signal with the specific pattern to the fan 1100 through the second specific chip pin 102, and trigger reception of a fan acknowledgment signal with the specific pattern from the fan 1100 through the first specific chip pin 101. When detecting that the signal includes the specific data with the specific pattern and the I2C protocol is used, the chip control module 110 may trigger processing of a clock signal through the second specific chip pin 102, and trigger processing of a data signal through the first specific chip pin 101.

In this embodiment, the fan driving chip 100 includes four chip pins 101-104 electrically connected to the chip control module 110. The fan 1100 includes four fan pins. The first chip pin 103 may be adapted for being electrically connected to the ground terminal 1103 (or reference voltage) of the fan 1100. The second chip pin 104 may be adapted for being electrically connected to the power signal terminal 1104 of the fan 1100 (e.g., the 12V power supply terminal). The first specific chip pin 101 is the third chip pin of the fan driving chip 100 and may be adapted for being electrically connected to the revolutions per minute (RPM) control terminal 1101 of the fan 1100. The RPM control terminal 1101 is for transmitting the TACO signal. The second specific chip pin 102 is the fourth chip pin of the fan driving chip 100 and may be adapted for being electrically connected to the PWM control terminal 1102 of the fan 1100. The PWM control terminal 1102 is for transmitting the PWM signal. That is, in this embodiment, the fan driving chip 100 does not add new pins but uses the existing 2 pins to support the ARGB function.

Although this embodiment describes the fan driving chip 100 including four chip pins and the fan 1100 including four fan pins, but the present disclosure is not limited herein. For example, the fan driving chip 100 may include six chip pins: the first chip pin 103, the second chip pin 104, a third chip pin (not illustrated in the figure), a fourth chip pin (not illustrated in the figure), the first specific chip pin 101, and the second specific chip pin 102. That is, the fan driving chip 100 may add two additional chip pins (i.e., the first specific chip pin 101 and the second specific chip pin 102) to support the ARGB function. In detail, the first chip pin 103 may be adapted for being electrically connected to the ground terminal 1103 (or reference voltage) of the fan 1100. The second chip pin 104 may be adapted for being electrically connected to the power signal terminal 1104 of the fan 1100 (e.g., the 12V power supply terminal). The third chip pin may be adapted for being electrically connected to the RPM control terminal of the fan 1100. The RPM control terminal is for transmitting the TACO signal. The fourth chip pin may be adapted for being electrically connected to the PWM control terminal of the fan 1100. The PWM control terminal is for transmitting the PWM signal.

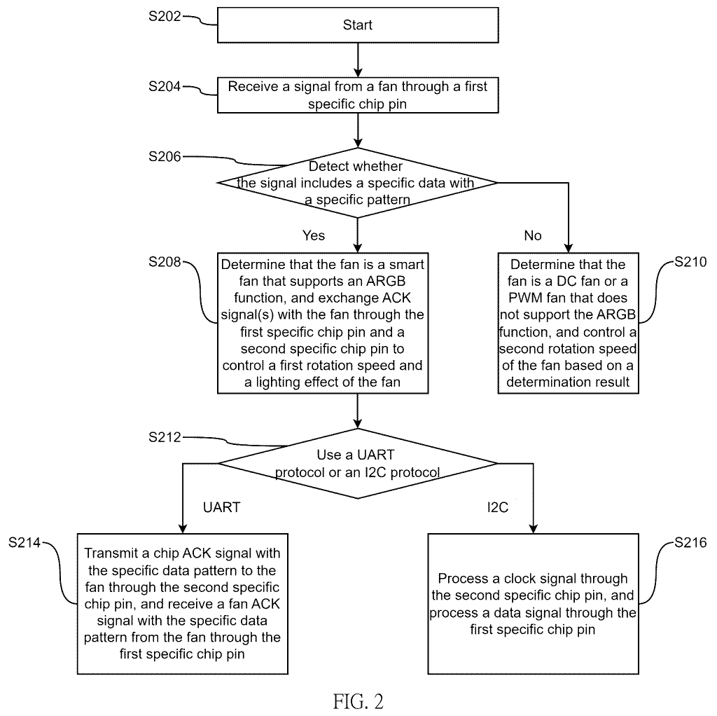

According to the aforementioned embodiments, a fan detection method may be summarized. FIG. 2 is a schematic flow chart of a fan detection method according to an embodiment of the present disclosure. Please refer to FIG. 2, the fan detection method includes the following steps:

In step S202, start, and then step S204 is performed. For example, the fan detection method can be performed after the motherboard powers on or the system completes a power-on reset (POR).

In step S204, receive a signal from a fan electrically connected to a fan driving chip through a first specific chip pin of the fan driving chip, and then step S206 is performed.

In step S206, detect whether the signal includes specific data with a specific pattern through the fan driving chip (e.g., a chip control module of the fan driving chip). When detecting that the signal includes the specific data with the specific pattern, step S208 is performed. When detecting that the signal does not include the specific data with the specific pattern, step S210 is performed.

In step S208, determine that the fan is a smart fan capable of supporting an ARGB function through the fan driving chip (e.g., the chip control module), and exchange at least one acknowledgement signal with the fan through the first specific chip pin and a second specific chip pin of the fan driving chip (e.g., triggered by the chip control module) to control a first rotation speed and a lighting effect of the fan, and then step S212 is performed.

In step S210, determine that the fan is a DC fan or a PWM fan that does not support the ARGB function through the fan driving chip (e.g., the chip control module), and control a second rotation speed of the fan based on a determination result.

In step S212, determine whether the fan driving chip uses a UART protocol or an I2C protocol (for communication with the fan) through the fan driving chip (e.g., the chip control module). When the UART protocol is used, step S214 is performed. When the I2C protocol is used, step S216 is performed.

In step S214, transmit a chip acknowledgment signal with the specific pattern to the fan through the second specific chip pin, and receive a fan acknowledgment signal with the specific pattern from the fan through the first specific chip pin.

In step S216, process a clock signal through the second specific chip pin, and process a data signal through the first specific chip pin.

FIG. 3 is a schematic circuit diagram of a smart fan according to an embodiment of the present disclosure. Please refer to FIG. 3, in this embodiment, the smart fan 300 supports ARGB function and is adapted for detecting a type of a chip 1300 electrically connected to the smart fan 300 and driving/controlling the smart fan 300. The chip 1300 may be, for example, a SIO chip, circuit, or device, but the present disclosure is not limited herein. The type of the chip 1300 may be, for example, a smart chip supporting the ARGB function or a traditional chip not supporting the ARGB function.

The smart fan 300 includes: a first specific fan pin 301, a second specific fan pin 302, and a fan control module 310 electrically connected to the first specific fan pin 301 and the second specific fan pin 302. The first specific fan pin 301 is adapted for transmitting first specific data with a specific pattern to the chip 1300 (e.g., a chip pin corresponding to the first specific fan pin 301). The second specific fan pin 302 is adapted for receiving a signal or a packet from the chip 1300. The fan control module 310 is adapted for detecting whether the signal includes second specific data with a specific (e.g., preset) pattern. When detecting that the signal includes the second specific data with the specific pattern, the fan control module 310 determines that the chip 1300 is a fan driving chip that supports the ARGB function (e.g., the fan driving chip 100 illustrated in FIG. 1), controls the smart fan 300 to operate using an ARGB fan mode, and triggers an exchange of at least one acknowledgement signal with the chip 1300 through the first specific fan pin 301 and the second specific fan pin 302 to control a first rotation speed and a lighting effect of the smart fan 300.

In some embodiments, the second specific data may be in response to or associated with the first specific data.

In some embodiments, when detecting that the signal does not include the second specific data with the specific pattern, the fan control module 310 may determine that the chip 1300 is a (traditional) chip that does not support the ARGB function, control the smart fan 300 to operate using (e.g., switch to) a PWM fan mode, trigger reception of a PWM signal through the second specific fan pin 302, and trigger transmission of a TACO signal through the first specific fan pin 301.

In some embodiments, the smart fan 300 may use a UART protocol (or interface) or an I2C interface to communicate with the chip 1300. When detecting that the signal includes the second specific data with the specific pattern and the UART protocol is used, the fan control module 310 may trigger reception of a chip acknowledgment signal with the specific pattern from the chip 1300 through the second specific fan pin 302, and trigger transmission of a fan acknowledgment signal with the specific pattern to the chip 1300 through the first specific fan pin 301. When detecting that the signal includes the second specific data with the specific pattern and the I2C protocol is used, the fan control module 310 may trigger processing of a clock signal through the second specific fan pin 302, and trigger processing of a data signal through the first specific fan pin 301.

In this embodiment, the smart fan 300 includes four fan pins electrically connected to the fan control module 310: the first fan chip pin 301, the second fan chip pin 302, the ground terminal 303, and the power signal terminal 304. The chip 1300 includes four chip pins: the first chip pin 1303, the second chip pin 1304, the third chip pin 1301, and the fourth chip pin 1302. The first chip pin 1303 may be adapted for being electrically connected to the ground terminal 303 (or reference voltage). The second chip pin 1304 may be adapted for being electrically connected to the power signal terminal 304 (e.g., the 12V power supply terminal). The first fan chip pin 301 may be the RPM control terminal of the smart fan 300 and may be adapted for being electrically connected to the third chip pin of the chip 1300. The RPM control terminal 1101 is for transmitting the TACO signal. The second fan chip pin 302 may be the PWM control terminal of the smart fan 300 and may be adapted for being electrically connected to the fourth chip pin 1302 of the chip 1300. The PWM control terminal is for transmitting the PWM signal. That is, in this embodiment, the smart fan 300 does not add new pins but uses the existing 2 pins to support the ARGB function.

Although this embodiment describes the smart fan 300 including four fan pins and the chip 1300 including four chip pins, but the present disclosure is not limited herein. For example, the smart fan 300 may include six fan pins: the ground terminal 303, the power signal terminal 304, a third fan pin (not illustrated in the figure), a fourth fan pin (not illustrated in the figure), the first specific fan pin 301, and the second specific fan pin 302. That is, the smart fan 300 may add two additional chip pins (i.e., the first specific fan pin 301 and the second specific fan pin 302) to support the ARGB function. In detail, the ground terminal 303 may be adapted for being electrically connected to the first chip pin 1303 of the chip 1300. The power signal terminal 304 may be adapted for being electrically connected to the second chip pin 1304 of the chip 1300. The third fan pin may be adapted for being electrically connected to the third chip pin of the chip 1300. The fourth fan pin may be adapted for being electrically connected to the fourth chip pin of the chip 1300.

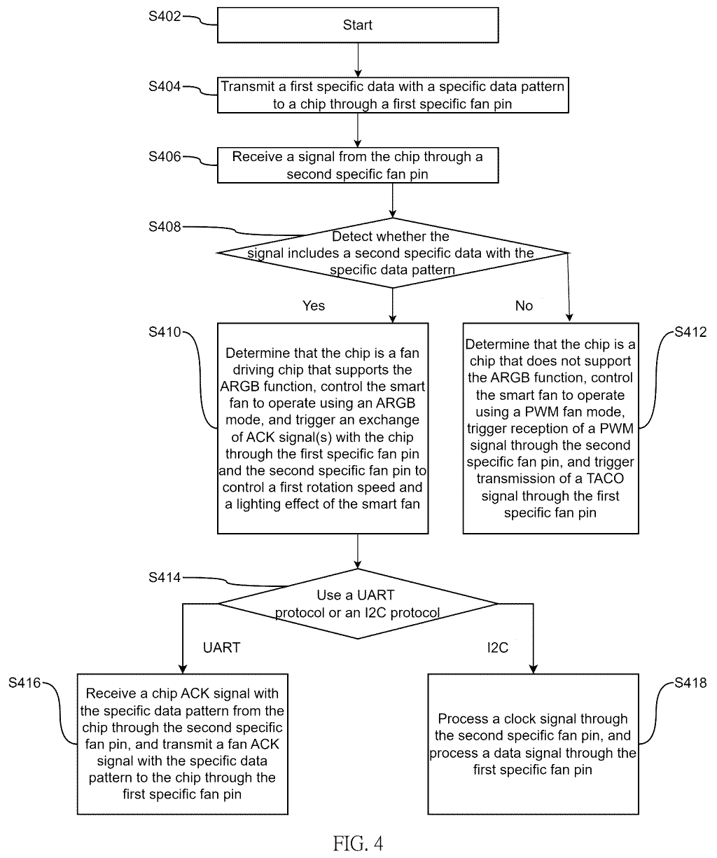

According to the aforementioned embodiments, a chip detection method may be summarized. FIG. 4 is a schematic flow chart of a chip detection method adapted for a smart fan according to an embodiment of the present disclosure. Please refer to FIG. 4, the chip detection method includes the following steps:

In step S402, start, and then step S404 is performed. For example, the chip detection method can be performed after the fan powers on or the system completes a power-on reset (POR).

In step S404, transmit first specific data with a specific pattern to a chip electrically connected to the smart fan through a first specific fan pin of a smart fan.

In step S406, receive a signal from the chip through a second specific fan pin of the smart fan, and then step S408 is performed.

In step S408, detect whether the signal includes second specific data with the specific pattern through the smart fan (e.g., a fan control module of the smart fan). When detecting that the signal includes the second specific data with the specific pattern, step S410 is performed. When detecting that the signal does not include the second specific data with the specific pattern, step S412 is performed.

In step S410, determine that the chip is a fan driving chip that supports the ARGB function through the fan control module (e.g., the fan control module), control the smart fan to operate using an ARGB mode, and trigger an exchange of at least one acknowledgement signal with the chip through the first specific fan pin and the second specific fan pin to control a first rotation speed and a lighting effect of the smart fan, and then step S414 is performed.

In step S402, determine that the chip is a chip that does not support the ARGB function through the smart fan (e.g., the fan control module), control the smart fan to operate using a PWM fan mode, trigger reception of a PWM signal through the second specific fan pin, and trigger transmission of a TACO signal through the first specific fan pin.

In step S414, determine whether the smart fan uses a UART protocol or an I2C protocol (for communication with the chip) through the smart fan (e.g., the fan control module). When the UART protocol is used, step S416 is performed. When the I2C protocol is used, step S418 is performed.

In step S416, receive a chip acknowledgment signal with the specific pattern from the chip through the second specific fan pin, and transmit a fan acknowledgment signal with the specific pattern to the chip through the first specific fan pin.

In step S418, process a clock signal through the second specific fan pin, and process a data signal through the first specific fan pin.

In summary, embodiments of the present disclosure can effectively achieve detecting the fan type and the chip type and providing the correct driving of the fan.

It should be understood that the examples and the embodiments described herein are for illustrative purpose only, and various modifications or changes in view of them will be suggested to those skilled in the art, and will be comprised in the spirit and scope of the application and the appendix with the scope of the claims.

What is claimed is:

1. A fan driving chip for detecting a type of a fan electrically connected to the fan driving chip, comprising:
a first specific chip pin adapted for receiving a signal from the fan;
a second specific chip pin;
a chip control module electrically connected to the first specific chip pin and the second specific chip pin, wherein:
when detecting that the signal comprises specific data with a specific pattern, the chip control module determines that the fan is a smart fan capable of supporting a specific function, and triggers an exchange of at least one acknowledgement signal with the fan through the first specific chip pin and the second specific chip pin to control a rotation speed and the specific function of the fan, wherein a specific effect of the specific function is a function other than fan rotation.

2. The fan driving chip according to claim 1, wherein the specific function is an addressable RGB (ARGB) function, and the specific effect is a lighting effect.

3. The fan driving chip according to claim 1, wherein:
when detecting that the signal comprises the specific data with the specific pattern and a UART protocol is used, the chip control module triggers transmission of a chip acknowledgment signal with the specific pattern to the fan through the second specific chip pin, and triggers reception of a fan acknowledgment signal with the specific pattern from the fan through the first specific chip pin.

4. The fan driving chip according to claim 1, wherein:
when detecting that the signal comprises the specific data with the specific pattern and an I2C protocol is used, the chip control module triggers processing of a clock signal through the second specific chip pin, and triggers processing of a data signal through the first specific chip pin.

5. The fan driving chip according to claim 1, further comprising:
a first chip pin adapted for being electrically connected to a ground terminal of the fan;
a second chip pin adapted for being electrically connected to a power signal terminal of the fan;
a third chip pin adapted for being electrically connected to a revolutions per minute (RPM) control terminal of the fan; and
a fourth chip pin adapted for being electrically connected to a pulse width modulation (PWM) control terminal of the fan, wherein:
the first specific chip pin is the third chip pin, and the second specific chip pin is the fourth chip pin, or
the first specific chip pin is a first additional chip pin other than the above four pins, and the second specific chip pin is a second additional chip pin other than the above four pins.

6. The fan driving chip according to claim 1, wherein when detecting that the signal does not comprise the specific data with the specific pattern, the chip control module determines that the fan is a direct current (DC) fan or a PWM fan that does not support the specific function.

7. A fan detection method, applied to detect a type of a fan electrically connected to a fan driving chip, comprising:
receiving a signal from the fan through a first specific chip pin of the fan driving chip;
detecting whether the signal comprises specific data with a specific pattern through a chip control module of the fan driving chip;
when detecting that the signal comprises the specific data with the specific pattern, determining that the fan is a smart fan capable of supporting a specific function, and triggering an exchange of at least one acknowledgement signal with the fan through the first specific chip pin and a second specific chip pin of the fan driving chip to control a rotation speed and the specific function of the fan, wherein a specific effect of the specific function is a function other than fan rotation; and
when detecting that the signal does not comprise the specific data with the specific pattern, determining that the fan is a direct current (DC) fan or a PWM fan that does not support an addressable RGB (ARGB) function.

8. A smart fan adapted for detecting a type of a chip electrically connected to the smart fan, wherein the smart fan is capable of supporting an addressable RGB (ARGB) function and comprises:
a first specific fan pin adapted for transmitting a first specific data with a specific pattern to the chip;
a second specific fan pin adapted for receiving a signal from the chip;
a fan control module electrically connected to the first specific fan pin and the second specific fan pin, wherein when detecting that the signal comprises second specific data with the specific pattern, the fan control module determines that the chip is a fan driving chip that supports the ARGB function, controls the smart fan to operate using an ARGB mode, and triggers an exchange of at least one acknowledgement signal with the chip through the first specific fan pin and the second specific fan pin to control a rotation speed and a lighting effect of the smart fan.

9. The smart fan according to claim 8, wherein when detecting that the signal comprises the second specific data with the specific pattern and a UART protocol is used, the fan control module triggers reception of a chip acknowledgment signal with the specific pattern from the chip through the second specific fan pin, and triggers transmission of a fan acknowledgment signal with the specific pattern to the chip through the first specific fan pin.

10. The smart fan according to claim 8, wherein when detecting that the signal comprises the second specific data with the specific pattern and an I2C protocol is used, the fan control module triggers processing of a clock signal through the second specific fan pin, and triggers processing of a data signal through the first specific fan pin.

11. The smart fan according to claim 8, further comprising:
a ground terminal;
a power signal terminal;
a revolutions per minute (RPM) control terminal; and
a pulse width modulation (PWM) control terminal, wherein:
the first specific fan pin is the RPM control terminal, and the second specific fan pin is the PWM control terminal, or
the first specific fan pin is a first additional fan pin other than the above four pins, and the second specific fan pin is a second additional fan pin other than the above four pins.

12. The smart fan according to claim 8, wherein when detecting that the signal does not comprise the second specific data with the specific pattern, the fan control module determines that the chip is a chip that does not support the ARGB function, controls the smart fan to operate using a PWM fan mode, triggers reception of a PWM signal through the second specific fan pin, and triggers transmission of a TACO signal through the first specific fan pin.
